(19) United States
(12) Patent Application Publication
(10) Pub. No.: US 2017/0284084 A1
(43) Pub. Date: Oct. 5, 2017

(54) MODULAR ACOUSTIC STRUCTURE

(71) Applicant: Visound Acústica SA, Armazem 9 (PT)

(72) Inventor: César Manuel Baras Carapinha, Charneca da Caparica (PT)

(21) Appl. No.: 15/090,755

(22) Filed: Apr. 5, 2016

(51) Int. Cl. E04B 1/82; E04B 1/84; G10K 11/16

(52) U.S. Cl. CPC E04B 1/8218; G10K 11/16; E04B 1/8409

(57) ABSTRACT

A modular acoustic structure includes a number of joined acoustic wall panels and acoustic ceiling tiles positioned atop the joined acoustic wall panels. The joined acoustic wall panels define a doorless aperture in the modular acoustic structure, an internal chamber, and a straight acoustic hallway connecting the doorless aperture and the internal chamber via an internal aperture. The straight acoustic hallway absorbs soundwaves travelling between the doorless aperture and the interior chamber. The acoustic wall and/or ceiling panels may include an acoustic absorptive surface and an acoustic reflective surface. The acoustic properties of the interior chamber and/or the straight acoustic hallway may be altered or tuned by changing which of the surfaces faces an interior of the modular acoustic structure. The size of the interior chamber and/or the modular acoustic structure may be adjustable by adding and/or removing acoustic wall and/or ceiling panels.

### FIELD

The described embodiments relate generally to acoustic structures. More particularly, the present embodiments relate to a modular acoustic structure that has a straight acoustic hallway, has an adjustable size, and/or has tunable acoustic properties.

### BACKGROUND

Acoustic properties of a space may be controlled to facilitate a number of activities. For example, voice and/or other sound recording may be performed in a space that is acoustically shielded to prevent sound from outside the space from interfering with the recording. By way of another example, manufacturing and/or other loud activities may be performed in an acoustically shielded space to prevent sound internal to the space from disturbing activities taking place outside of the space.

In many situations, acoustic materials may be mounted to existing surfaces in a room or other enclosure in order to control acoustic properties. For example, acoustic tiles and/or other acoustic materials may be attached to walls, ceilings, floors, and so on. However, in many cases, attaching acoustic materials in this way may be relatively permanent. Controlling acoustic properties in this way may render the room less fit for other purposes.

In other situations, an acoustic structure such as an acoustic cabin, booth, sound studio, or other structure may be constructed. The constructed acoustic structure may be located in a space where attachment of acoustic materials is not feasible, such as outdoors. Further, the constructed acoustic structure may be assembled in a room or other enclosure to control acoustic properties within the acoustic structure without attachment of acoustic materials to walls or other surfaces of the room.

### SUMMARY

The present disclosure relates to a modular acoustic structure. The modular acoustic structure includes an interior chamber that is acoustically isolated from an external environment by an acoustic hallway that absorbs soundwaves. The modular acoustic structure may be doorless, have alterable acoustic properties, and/or have a changeable size.

In various embodiments, a modular acoustic structure includes acoustic panels joined together, an interior chamber defined by the acoustic panels, a doorless aperture defined by the acoustic panels, and a straight acoustic hallway defined by the acoustic panels. The straight acoustic hallway connects the doorless aperture and the interior chamber and absorbs soundwaves travelling between the doorless aperture and the interior chamber.

In some examples, the modular acoustic structure further includes a window coupled to one of the acoustic panels. In other examples, other components may be coupled to acoustic panels.

In numerous examples, the acoustic panels define an interior aperture between the straight acoustic hallway and the interior chamber. In such examples, the interior aperture may be perpendicular to the straight acoustic hallway.

In various examples, the acoustic panels defining the straight acoustic hallway include an acoustic absorptive interior surface and an acoustic reflective exterior surface. In some examples, at least one of the acoustic panels is positioned between the straight acoustic hallway and the interior chamber. In numerous examples, the acoustic panels each comprise a layer of wood, a layer of polyurethane foam, and a layer of fabric.

In some embodiments, a modular acoustic structure includes acoustic wall sections joined together; acoustic ceiling tiles placed on the acoustic wall sections to form a ceiling, at least one of the acoustic wall sections or the acoustic ceiling tiles include an acoustic absorptive surface and an acoustic reflective surface; an interior chamber defined by the acoustic wall sections; an aperture defined by the acoustic wall sections, and an acoustic tunnel defined by the acoustic wall sections that absorbs soundwaves travelling between the aperture and the interior chamber. Changing which of the acoustic absorptive surface and the acoustic reflective surface faces an interior of the interior chamber alters acoustic properties of the interior chamber. The acoustic ceiling tiles may be unfixed from the acoustic wall sections

In various examples, the acoustic reflective surface comprises wood. In some examples, the acoustic absorptive surface comprises polyurethane. In such examples, fabric may be positioned on the polyurethane.

In numerous examples, changing the acoustic reflective surface to face the interior of the interior chamber increases reflection of soundwaves within the interior chamber. In various examples, changing the acoustic absorptive surface to face the interior of the interior chamber decreases reflection of soundwaves within the interior chamber.

In numerous embodiments, a modular acoustic structure includes acoustic structural modules removably joined together, an interior chamber defined by the acoustic structural modules, an aperture defined by the acoustic structural modules, and an acoustic passageway defined by the acoustic structural modules. The acoustic passageway connects the aperture and the interior chamber and absorbs soundwaves travelling between the aperture and the interior chamber. A size of the interior chamber is adjustable by joining an additional acoustic structural module to the acoustic structural modules or removing one of the acoustic structural modules. The modular acoustic structure may also include joining structures positioned between the acoustic structural module.

In various examples, the acoustic structural modules define a gap underneath the modular acoustic structure. In some examples, the aperture ventilates the interior chamber.

In numerous examples, the additional acoustic structural module is joined to the acoustic structural modules by separating two modules of the acoustic structural modules that are joined and joining the acoustic structural module to the two modules. In various examples, removing the one of the acoustic structural modules includes separating the one of the acoustic structural modules from two modules that adjoin the one of the acoustic structural modules and joining the two modules to each other.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example modular acoustic structure.

FIG. 2 depicts a top view of the modular acoustic structure of FIG. 1 with the ceiling and top joining structures removed to show the straight acoustic hallway, the interior aperture, and the interior chamber.

FIG. 3 depicts the modular acoustic structure of FIG. 2 after the size of the modular acoustic structure has been increased by adding acoustic wall panels.

FIG. 4 depicts the modular acoustic structure of FIG. 2 after the size of the modular acoustic structure has been decreased by removing acoustic wall panels.

FIG. 5 depicts a cross-sectional view of an example embodiment of the acoustic wall panel of the modular acoustic structure of FIG. 2, taken along the line A-A in FIG. 2.

FIG. 6 depicts the modular acoustic structure of FIG. 2 after one of the acoustic wall panels has been flipped to alter acoustic properties of the interior chamber.

FIG. 7 is a flow chart illustrating an example method for providing a modular acoustic structure. This method may provide one or more of the modular acoustic structures of FIGS. 1-6.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, and computer program products that embody various elements of the present disclosure. However, it should be understood that the described disclosure may be practiced in a variety of forms in addition to those described herein.

The following disclosure relates to a modular acoustic structure. The modular acoustic structure may include a number of joined acoustic wall panels and acoustic ceiling tiles positioned atop the joined acoustic wall panels. The joined acoustic wall panels may define a doorless aperture in the modular acoustic structure, an internal chamber, and a straight acoustic hallway connecting the doorless aperture and the internal chamber via an internal aperture. The straight acoustic hallway may absorb soundwaves travelling between the doorless aperture and the interior chamber. The acoustic wall and/or ceiling panels may include an acoustic absorptive surface and an acoustic reflective surface. The acoustic properties of the interior chamber and/or the straight acoustic hallway may be altered or tuned by changing which of the surfaces faces an interior of the modular acoustic structure. The size of the interior chamber and/or the modular acoustic structure may be adjustable by adding and/or removing acoustic wall and/or ceiling panels. In this way, the modular acoustic structure may be highly flexible and inexpensive compared to other acoustic structures.

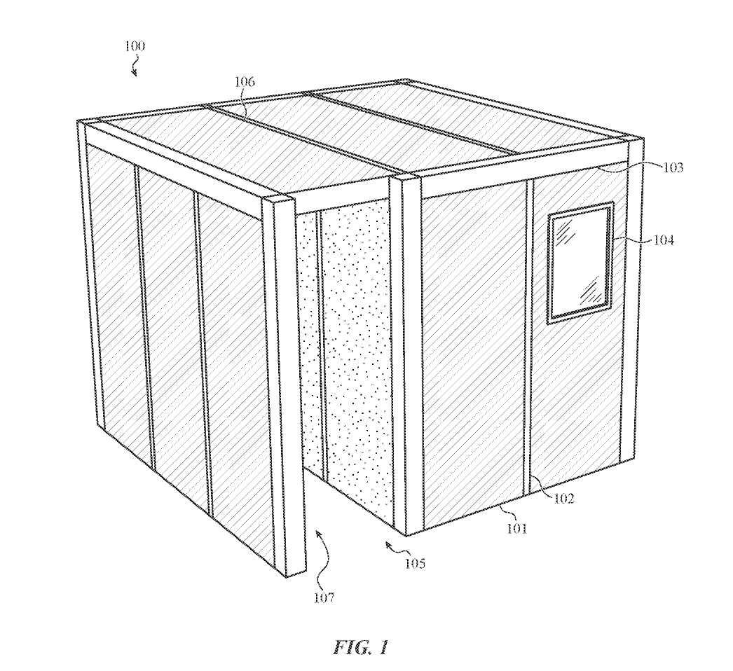

These and other embodiments are discussed below with reference to FIGS. 1-7. However, those skilled in the art will readily appreciate that the detailed description given herein with respect to these Figures is for explanatory purposes only and should not be construed as limiting.

FIG. 1 depicts an example modular acoustic structure 100. The modular acoustic structure 100 may include a number of acoustic wall panels 101 (or tiles, sections, structural modules, or other components) removably joined together and a number of acoustic ceiling tiles 106 (or panels, sections, structural modules, or other components). The acoustic wall panels 101 may be joined by side joining structures 102 and/or top joining structures 103. The acoustic wall panels 101 may define a doorless aperture 105 that connects the modular acoustic structure 100 to an external environment 108.

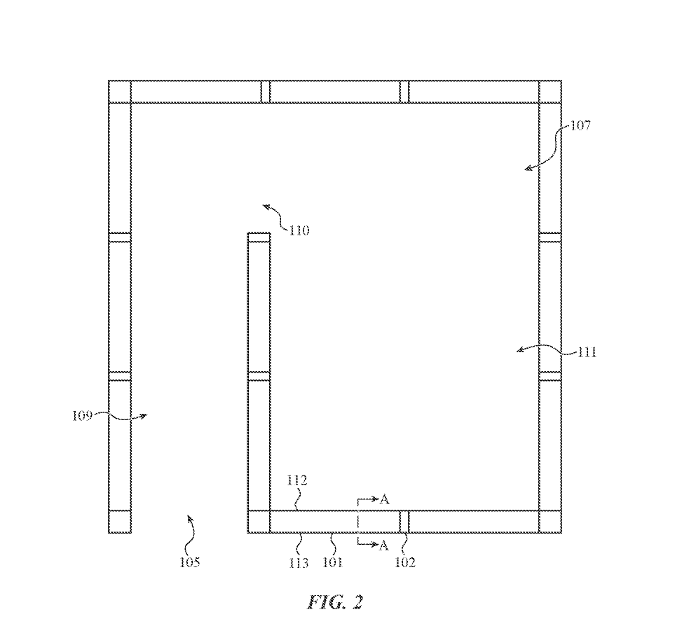

FIG. 2 depicts a top view of the modular acoustic structure 100 of FIG. 1 with the side and top joining structures 102, 103 removed to show the interior of the modular acoustic structure 100. Further, the acoustic wall panels 101 may define a straight acoustic hallway 109 (or tunnel, passageway, and so on), an interior chamber 111 connected to the straight acoustic hallway 109, and an interior aperture 110 between the straight acoustic hallway 109 and the interior chamber 111 that may perpendicularly connect the straight acoustic hallway 109 to the interior chamber 111. The acoustic wall panels 101 may form outer walls of the modular acoustic structure 100 as well as an interior wall positioned between the straight acoustic hallway 109 and the interior chamber 111. The straight acoustic hallway 109 may absorb at least a portion of the soundwaves travelling between the doorless aperture 105 and the interior chamber 111. In this way, the acoustic properties of the interior chamber 111 may be controlled even though the interior chamber 111 may not be physically sealed off (such as using a door or other blocking structure) from the external environment 108.

For example, the modular acoustic structure 100 may at least partially isolate the interior chamber 111 from sound in the external environment 108. By way of another example, the modular acoustic structure 100 may at least partially isolate the external environment from sound in interior chamber 111. By way of still another example, the modular acoustic structure 100 may control the acoustic properties of sound within the interior chamber 111.

The acoustic wall panels 101 and/or the acoustic ceiling tiles 106 may include an acoustic reflective surface 113 and/or an acoustic absorptive surface 112. The acoustic reflective surface 113 may at least partially block the passage of and/or reflect soundwaves and the acoustic absorptive surface 112 may at least partially absorb soundwaves. The acoustic reflective surfaces 113 and/or the acoustic absorptive surfaces 112 may aid in controlling the acoustic properties of the interior chamber 111, the straight acoustic hallway 109, and so on. The acoustic reflective surfaces 113 and/or the acoustic absorptive surfaces 112 may also aid in at least partially acoustically isolating the interior chamber 111 from the external environment 108.

With reference to FIGS. 1 and 2, the straight acoustic hallway 109 may absorb soundwaves travelling between the doorless aperture 105 and the interior chamber 111 without utilizing curving walls, blocking components, and/or other elements typically used that add to complexity, size, and cost of acoustic booths, cabins, sound studios, or other structures. As such, the straight acoustic hallway 109 may allow the modular acoustic structure 100 to be less complex, more easily ventilated, and less expensive than typical acoustic structures. Further, the straight acoustic hallway 109 may allow the modular acoustic structure 100 to maximize the size of the interior chamber 111 compared to the overall size of the modular acoustic structure 100.

Further, as the doorless aperture 105 is open, the modular acoustic structure 100 may be ventilated by the doorless aperture 105 rather than utilizing a ventilation and/or cooling system. Inclusion of ventilation and/or cooling systems may increase expense and/or may require space within an acoustic structure. As such, being able to omit ventilation and/or cooling systems may further reduce cost and/or complexity and/or may maximize available space in the interior chamber 111. Additionally, the open configuration of the modular acoustic structure 100 may feel less claustrophobic to users than closed acoustic structures, such as those sealed using doors or similar components.

The modular acoustic structure 100 may also include one or more windows 104 and/or similar light passage components. These windows may be coupled to one or more acoustic wall panels 101, acoustic ceiling tiles 106, and so on. As such, the modular acoustic structure 100 may omit lighting systems, even further reducing cost and/or complexity and/or maximizing available space in the interior chamber 111.

The acoustic wall panels 101 may define a gap 107 underneath the modular acoustic structure 100. Hence, as the straight acoustic hallway 109 may at least partially acoustically isolate the interior chamber 111 from the external environment 108 without a floor, the modular acoustic structure 100 may omit a floor. This may further reduce complexity and cost.

The side and top joining structures 102, 103 may removably join the acoustic wall panels 101. For example, in some embodiments, the side joining structures 102 may define cavities into which portions of adjacent acoustic wall panels 101 may be inserted, positioning the side joining structures 102 between adjacent acoustic wall panels 101. Top joining structures 103 may then be placed over tops of the adjacent acoustic wall panels 101and the side joining structures 102. Coupling elements (such as bolts, screws, and/or other attachment mechanisms) may then attach the top joining structures 103 to the side joining structures 102 to form a single structure. In this way, various acoustic wall panels 101 may be non-destructively joined together and/or separated in a variety of configurations using a minimum amount of time and effort. However, it is understood that this is an example. In other embodiments, the acoustic wall panels 101 may be joined together and/or separated using other joining structures and/or mechanisms without departing from the scope of the present disclosure.

In various embodiments, the acoustic ceiling tiles 106 may be unfixed from the joined acoustic wall panels 101. Rather, the acoustic ceiling tiles 106 may be placed or positioned atop the joined acoustic wall panels 101. This arrangement may further simplify construction and alteration of the modular acoustic structure 100. However, it is understood that this is an example. In other embodiments, the acoustic ceiling tiles 106 may be fixed to the joined acoustic wall panels 101 using various attachment mechanisms without departing from the scope of the present disclosure.

The size of the modular acoustic structure 100, the interior chamber 111, the straight acoustic hallway 109, and so on may be adjustable. The size may be increased by adding one or more acoustic wall panels 101 and/or acoustic ceiling tiles 106, decreased by removing one or more acoustic wall panels 101 and/or acoustic ceiling tiles 106, and so on.

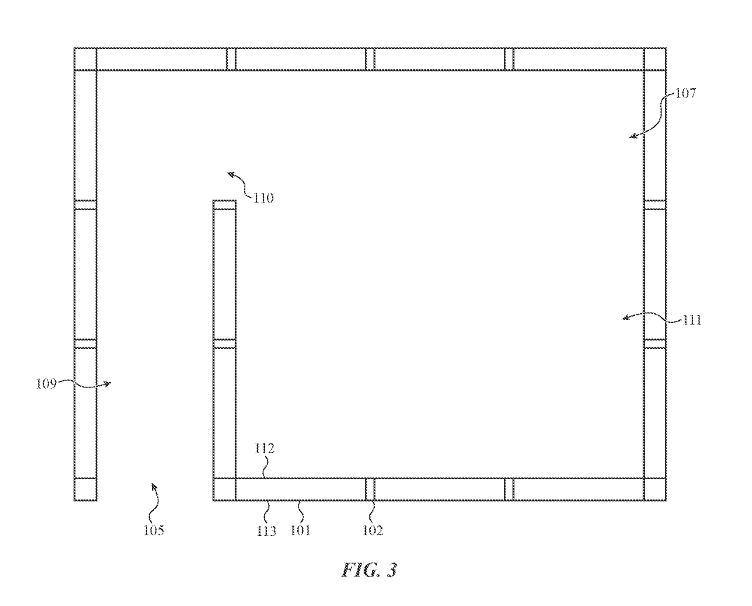

For example, FIG. 3 depicts the modular acoustic structure 100 of FIG. 2 after the size of the modular acoustic structure 100 has been increased by adding acoustic wall panels 101. The side and top joining structures 102, 103 joining two adjacent acoustic wall panels 101 were removed to allow separation of the two adjacent acoustic wall panels 101. An additional acoustic wall panel 101 was then added between the previously adjacent acoustic wall panels 101. Side and top joining structures 102, 103 were then used to join the three adjacent acoustic wall panels 101. Thus, the size of the interior chamber 111 (and/or other portions of the modular acoustic structure 100) can be expanded using a minimum amount of time and effort. As the size of the modular acoustic structure 100 can be adjusted, the modular acoustic structure 100 may be flexible enough to be used in a variety of different situations rather than being replaced with a differently sized modular acoustic structure 100.

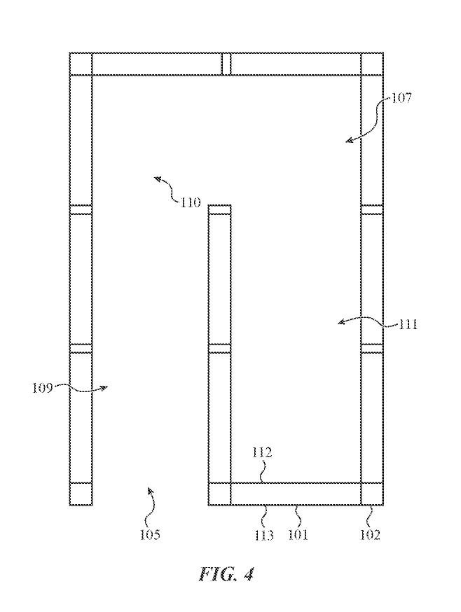

By way of another example, FIG. 4 depicts the modular acoustic structure 100 of FIG. 2 after the size of the modular acoustic structure 100 has been decreased by removing acoustic wall panels 100. The side and top joining structures 102, 103 joining three adjacent acoustic wall panels 101 were removed to allow separation of the three adjacent acoustic wall panels 101. The middle acoustic wall panel 101 of the three was then removed and side and top joining structures 102, 103 were then used to join the remaining two acoustic wall panels 101. Thus, the size of the interior chamber 111 (and/or other portions of the modular acoustic structure 100) can be contracted in a variety of different ways.

Referring again to FIGS. 1 and 2, as discussed above, the acoustic wall panels 101 and/or the acoustic ceiling tiles 106 may include an acoustic reflective surface 113 that may block the passage of and/or reflect soundwaves and/or an acoustic absorptive surface 112 that may absorb soundwaves. For example, in some embodiments, the acoustic reflective surface 113 may be formed from a material such as wood, metal, and so on. By way of another example, in various embodiments, the acoustic absorptive surface 112 may be formed of polyurethane foam, fabric, fabric covered polyurethane foam, and so on.

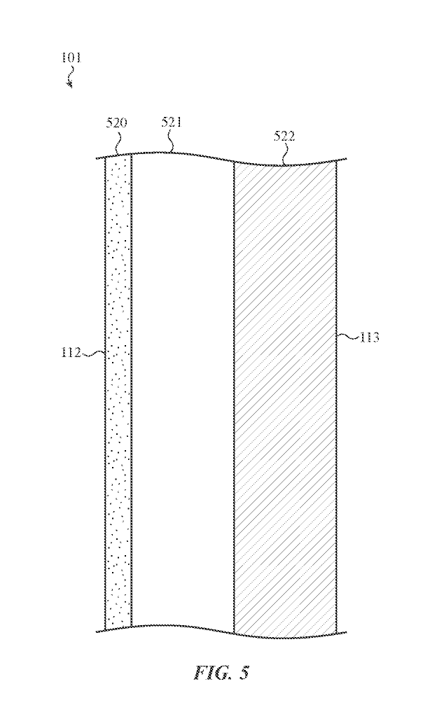

FIG. 5 depicts a cross-sectional view of an example embodiment of the acoustic wall panel 101 of the modular acoustic structure 100 of FIG. 2, taken along the line A-A in FIG. 2. The acoustic wall panel 101 may include a layer of wood 522 that defines the acoustic reflective surface 113. The acoustic wall panel may also include a layer of polyurethane foam 521 with a layer of fabric 520 formed thereon that define the acoustic absorptive surface 112. However, it is understood that this is an example and that other configurations of various materials are possible and contemplated without departing from the scope of the present disclosure.

The layer of wood 522 may function to block and/or reflect soundwaves. The layers of polyurethane foam 521 and fabric 520 may each absorb soundwaves. However, layers of polyurethane foam 521 and fabric 520 may each absorb different frequency ranges of soundwaves differently. Further, the fabric 520 may filter soundwaves and the polyurethane foam 521 may absorb soundwaves that pass through the filtering of the fabric 520. As such, combining the layers of polyurethane foam 521 and fabric 520 may allow for fine tuning of which frequency ranges of soundwaves are absorbed, how they are absorbed, and so on.

Although FIG. 5 illustrates the layers of wood 522, polyurethane foam 521, and fabric 520 as flat layers, it is understood that this is an example. In various embodiments, one or more of the wood 522, polyurethane foam 521, and fabric 520 may be shaped in various ways. For example, the layers of polyurethane foam 521 and fabric 520 may be shaped to form various sound baffles and/or other acoustic features that affect how the layers of polyurethane foam 521 and fabric 520 absorb, direct, and/or otherwise affect soundwaves.

With reference again to FIGS. 1 and 2, the acoustic absorptive surface 112 of the acoustic wall panels 101 may be an acoustic absorptive interior surface (e.g., interior as they may face the interior of the modular acoustic structure 100, such as toward the interior of the acoustic hallway 109). Similarly, the acoustic reflective surface 113 may be an acoustic absorptive exterior surface (e.g., exterior as they may face away from the interior of the modular acoustic structure 100, such as toward the external environment 108). However, it is understood that this is an example. In various situations, an acoustic wall panel 101 may be oriented such that the acoustic absorptive surface 112 faces the exterior environment 108 and/or the acoustic reflective surface 113 faces the interior of the modular acoustic structure 100, the acoustic hallway 109, the interior chamber 111, and so on. Changing the orientation of the acoustic wall panel 101 to change which of the acoustic absorptive surface 112 or the acoustic reflective surface 113 faces an interior may alter the acoustic properties of the modular acoustic structure 100, the acoustic hallway 109, the interior chamber 111, and so on.

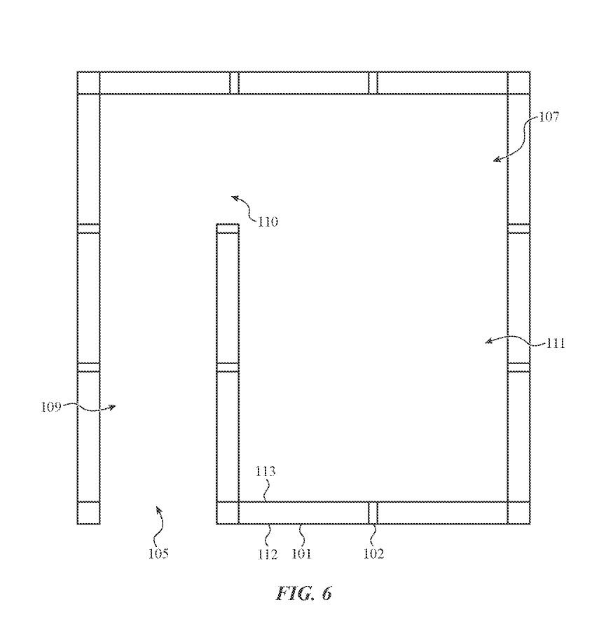

For example, FIG. 2 illustrates one of the acoustic wall panels 101 having an acoustic absorptive surface 112 facing an interior of the interior chamber 111. FIG. 6 depicts the modular acoustic structure 100 of FIG. 2 after the acoustic wall panel 101 has been flipped so that the acoustic reflective surface 113 faces the interior of the interior chamber 111. In this way, the acoustic wall panels 101 may be “flipped” to alter the acoustic properties of the interior chamber 111.

Changing the acoustic absorptive surface 112 to face the interior chamber 111 may decrease reflection of soundwaves in the interior chamber 111, altering the acoustic properties of the interior chamber 111 such that sound in the interior chamber 111 is “softer.” Conversely, changing the acoustic reflective surface 113 to face the interior chamber 111 may increase reflection of soundwaves in the interior chamber 111, altering the acoustic properties of the interior chamber 111 such that sound in the interior chamber 111 is “brighter.” In this way, the acoustic properties of the interior chamber may be altered using a minimum amount of time and effort. As the acoustic properties of the interior chamber 111 (and/or other components of the modular acoustic structure 100) can be altered, the modular acoustic structure 100 may be flexible enough to be used in a variety of different situations rather than being replaced with a modular acoustic structure 100 configured with different acoustic properties.

In some embodiments, acoustic wall panels 101 and/or acoustic ceiling tiles 106 defining the straight acoustic hallway 109 may also be flipped to change which of acoustic absorptive surfaces 112 or acoustic reflective surfaces 113 face inward. However, in many implementations, acoustic absorptive surfaces 112 may be faced inward to ensure that the straight acoustic hallway 109 absorbs sufficient soundwaves travelling between the interior chamber 111 and the doorless aperture 105 so that the interior chamber 111 is adequately acoustically isolated from the external environment 108.

Although the above describes the acoustic wall panels 101 and the acoustic ceiling tiles 106 as different components, it is understood that these are examples. In various embodiments, identically configured and/or substantially identically configured acoustic panels may be used as either acoustic wall panels 101 or the acoustic ceiling tiles 106. In such an embodiment, identification of an acoustic panel as either an acoustic wall panel 101 or an acoustic ceiling tile 106 may depend on how the acoustic panel is used and positioned in the modular acoustic structure 100.

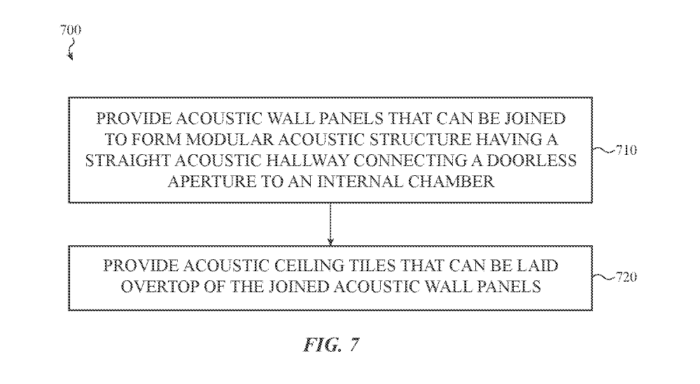

FIG. 7 is a flow chart illustrating an example method for providing a modular acoustic structure. This method may provide one or more of the modular acoustic structures 100 of FIGS. 1-6.

At 710, acoustic wall panels may be provided. The acoustic wall panels may be configured to be joined to form a modular acoustic structure. The modular acoustic structure formed by joining the acoustic wall panels may have a straight acoustic hallway connecting a doorless aperture to an internal chamber.

At 720, acoustic ceiling tiles may be provided. The acoustic ceiling tiles may be configured to be laid over top of the joined acoustic wall panels.

Although the example method 700 is illustrated and described as including particular operations performed in a particular order, it is understood that this is an example. In various implementations, various orders of the same, similar, and/or different operations may be performed without departing from the scope of the present disclosure.

For example, in various implementations, the method 700 may include the additional operation of constructing the acoustic wall panels. Additionally or alternatively, the method 700 may include the additional operation of constructing the acoustic ceiling tiles.

As described above and illustrated in the accompanying figures, the present disclosure relates to a modular acoustic structure. The modular acoustic structure may include a number of joined acoustic wall panels and acoustic ceiling tiles positioned atop the joined acoustic wall panels. The joined acoustic wall panels may define a doorless aperture in the modular acoustic structure, an internal chamber, and a straight acoustic hallway connecting the doorless aperture and the internal chamber via an internal aperture. The straight acoustic hallway may absorb soundwaves travelling between the doorless aperture and the interior chamber. The acoustic wall and/or ceiling panels may include an acoustic absorptive surface and an acoustic reflective surface. The acoustic properties of the interior chamber and/or the straight acoustic hallway may be altered or tuned by changing which of the surfaces faces an interior of the modular acoustic structure. The size of the interior chamber and/or the modular acoustic structure may be adjustable by adding and/or removing acoustic wall and/or ceiling panels. In this way, the modular acoustic structure may be highly flexible and inexpensive compared to other acoustic structures.

In the present disclosure, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A modular acoustic structure, comprising:
acoustic panels joined together;
an interior chamber defined by the acoustic panels;
a doorless aperture defined by the acoustic panels;
a straight acoustic hallway defined by the acoustic panels that:
has a length of at least two of the acoustic panels;
connects the doorless aperture and an interior aperture between the straight acoustic hallway and the interior chamber such that the doorless aperture and the interior aperture are non-aligned; and
absorbs soundwaves travelling between the doorless aperture and the interior chamber.

2. The modular acoustic structure of claim 1, further comprising a window coupled to one of the acoustic panels.

3. The modular acoustic structure of claim 1, wherein the acoustic panels define the interior aperture between the straight acoustic hallway and the interior chamber.

4. The modular acoustic structure of claim 3, wherein the interior aperture is perpendicular to the straight acoustic hallway.

5. The modular acoustic structure of claim 1, wherein the acoustic panels defining the straight acoustic hallway include an acoustic absorptive interior surface and an acoustic reflective exterior surface.

6. The modular acoustic structure of claim 1, wherein at least one of the acoustic panels is positioned between the straight acoustic hallway and the interior chamber.

7. The modular acoustic structure of claim 1, wherein the acoustic panels each comprise a layer of wood, a layer of polyurethane foam, and a layer of fabric.

8. A modular acoustic structure, comprising:
acoustic wall sections joined together;
acoustic ceiling tiles placed on the acoustic wall sections to form a ceiling, at least one of the acoustic wall sections or the acoustic ceiling tiles include an acoustic absorptive surface and an acoustic reflective surface;
an interior chamber defined by the acoustic wall sections;
an aperture defined by the acoustic wall sections;
an acoustic tunnel at least two of the acoustic wall sections in length defined by the acoustic wall sections that absorbs soundwaves travelling between the aperture and the interior chamber; and
an interior aperture defined between the interior chamber and the acoustic tunnel that is non-aligned with the aperture; wherein:
changing which of the acoustic absorptive surface and the acoustic reflective surface faces an interior of the interior chamber alters acoustic properties of the interior chamber.

9. The modular acoustic structure of claim 8, wherein the acoustic reflective surface comprises wood.

10. The modular acoustic structure of claim 8, wherein the acoustic absorptive surface comprises polyurethane.

11. The modular acoustic structure of claim 10, further comprising fabric positioned on the polyurethane.

12. The modular acoustic structure of claim 8, wherein changing the acoustic reflective surface to face the interior of the interior chamber increases reflection of soundwaves within the interior chamber.

13. The modular acoustic structure of claim 8, wherein changing the acoustic absorptive surface to face the interior of the interior chamber decreases reflection of soundwaves within the interior chamber.

14. The modular acoustic structure of claim 8, wherein the acoustic ceiling tiles are unfixed from the acoustic wall sections.

15. A modular acoustic structure, comprising:
acoustic structural modules removably joined together;
an interior chamber defined by the acoustic structural modules;
an aperture defined by the acoustic structural modules;
an interior aperture defined between the aperture and the interior chamber that is non-aligned with the aperture; and
an acoustic passageway at least two of the acoustic structural modules in length defined by the acoustic structural modules that connects the aperture and the interior aperture and absorbs soundwaves travelling between the aperture and the interior chamber;
wherein a size of the interior chamber is adjustable by:
joining an additional acoustic structural module to the acoustic structural modules; or
removing one of the acoustic structural modules.

16. The modular acoustic structure of claim 15, wherein the acoustic structural modules define a gap underneath the modular acoustic structure.

17. The modular acoustic structure of claim 15, wherein the additional acoustic structural module is joined to the acoustic structural modules by:
separating two modules of the acoustic structural modules that are joined; and
joining the additional acoustic structural module to the two modules.

18. The modular acoustic structure of claim 15, wherein removing the one of the acoustic structural modules comprises:
separating the one of the acoustic structural modules from two modules that adjoin the one of the acoustic structural modules; and
joining the two modules to each other.

19. The modular acoustic structure of claim 15, further comprising joining structures positioned between the acoustic structural modules.

20. The modular acoustic structure of claim 15, wherein the aperture ventilates the interior chamber.
